(19) United States
(12) Patent Application Publication
(10) Pub. No.: US 2017/0101822 A1
(43) Pub. Date: Apr. 13, 2017

(54) Ladder Wheel

(71) Applicant: Thomas Steiner, Chilton, WI (US)

(72) Inventor: Thomas Steiner, Chilton, WI (US)

(21) Appl. No.: 14/878,067

(22) Filed: Oct. 8, 2015

(51) Int. Cl. E06C 7/42

(52) U.S. Cl. CPC E06C 7/42

(57) ABSTRACT

The invention relates to a ladder that includes a support device. A mounting plate is securely fixed to an outer surface of a side rail of a ladder, which is adjacent to one end of the ladder. A removable wheel assembly has a frame that is removably supported on mating interfitting parts between the wheel assembly and the support member or plate. The support member includes a bracket member and a rotatable device, such as a wheel, that is housed in the bracket member. The bracket member includes a U-shaped section for retaining the wheel member, and an elongated section for attachment to the ladder. The device is used for easily moving the ladder from one place to another. The interchange from one ladder to another is simply by unbuckling it from one ladder, pulling it off, sliding it on the new ladder, and buckling it back on. The ladder wheel should be placed between the top of the ladder and the first step from the top of the ladder.

### CROSS REFERENCE TO RELATED APPLICATION

Not Applicable

### FEDERALLY SPONSORED RESEARCH AND DEVELOPMENT Not Applicable

### MICROFICHE APPENDIX

Not Applicable

### BACKGROUND OF THE INVENTION

(1) Field of Invention

The invention relates to ladder supports. More particularly, the present invention relates to a support device that facilitates movement of a ladder. The invention relates to ladders that employ wheels as supports for easy transportation.

(2) Background of Invention

The statements in this section merely provide background information related to the present disclosure, and may not constitute prior art.

Workmen, such as painters, carpenters, and roofers, must often reposition a ladder against an inclined work surface, such as inclined and vertical surfaces. The repositioning of a ladder, such as the extension member of an extension ladder, against these surfaces is a time consuming operation. The time wasted in repositioning the ladder adds substantial expense to labor intensive operations, such as painting. This expense is also increased because two people are often needed to reposition long, relatively heavy ladders. Moreover, reposition of the ladder requires moving the ladder away from the wall and maintaining the ladder in a balanced position until the ladder is again resting against the wall. If this balanced position is lost, the ladder can crash and cause property damage and injure the user.

Various wheeled dollies have been used for different types of ladders and other equipment. U.S. Pat. No. 6,708,993 illustrates a ladder dolly that is used in connection with ladders that have hollow rungs opening to the side rails of the ladder.

Many kinds of ladders and stepping-stools are known in the art. U.S. Pat. No. 5,566,780, dated Oct. 22, 1996, was issued to Harry M. Hambrough. It describes a combination cart and ladder apparatus including a first and a second ladder assembly.

Peter DiSario's U.S. Pat. No. 5,727,799 presents a dolly for supporting a ladder during movement to a work site. U.S. Pat. No. 5,086,872 to Fan-Nam Lim discloses a foldable ladder equipped with a pair of wheels so that the ladder can be converted into a push cart for the transportation of various goods. In their U.S. Pat. No. 4,049,283, Brookes et al. describe a caddy for transporting a heavy ladder to a work site.

In his U.S. Pat. No. 5,382,032, dated Jan. 17, 1995, Wilson discloses a wheeled stepladder dolly. U.S. Pat. No. 5,105,908 was issued to Harvey J. Freund on Apr. 21, 1992. It reveals a kit that may be used to convert a ladder tree stand into a towable trailer that may be connected to a motorized vehicle.

U.S. Pat. No. 5,882,023, issued to William F. Swager, discloses a wheeled transport device for maneuvering elongated objects in a simplified manner. U.S. Pat. No. 5,082,086 was issued to James F. Kerr on Jan. 21, 1992. This patent discloses a ladder including wheels normally received off the ground, and four legs normally supporting the ladder.

What is needed is a ladder wheel device for moving ladders easily from one position to another. The development of a simple ladder transportation system that would reduce or obviate the need for retraction, weight, size, and cost, yet still allow one person to easily maneuver and transport a ladder from place-to-place without injury, would constitute a major advance and would satisfy a long felt need in the construction and maintenance industries.

Additional objectives, advantages, and novel features of the invention will be set forth, in part, in the description as follows. They will become apparent to those skilled in the art upon examination of the following, or may be learned by practice of the invention. The objectives and advantages of the invention may be realized and attained by means of the instrumentalities and combinations that are particularly pointed out in the appended claims.

The present invention has arisen to mitigate and/or obviate the afore-described disadvantages of the conventional ladders with wheels.

A need exists for devices that facilitate repositioning of ladders, as well as ladders that can be readily positioned to a desired location and which overcome the disadvantages of conventional ladders.

Accordingly, the art of rolling ladders could benefit from a rolling ladder that is capable of traversing from one place to another.

### SUMMARY OF THE INVENTION

In view of the foregoing disadvantages inherent in the known types of ladders now present in the prior art, the present invention provides an improved ladder with wheels for transportion. The system of the present invention provides a ladder wheel that can be used with ladders of all types. As such, the general purpose of the present invention, which will be described subsequently in greater detail, is to provide a ladder wheel for moving ladders that has all of the advantages of the prior art, and none of the disadvantages.

There has thus been outlined, rather broadly, the more important features of the invention in order that the detailed description thereof that follows may be better understood and in order that the present contribution to the art may be better appreciated.

As such, those skilled in the art will appreciate that the conception upon which this disclosure is based may be readily utilized as a basis for the designing of other structures, methods, and systems for carrying out the several purposes of the present invention. It is important, therefore, that the claims be regarded as including such equivalent constructions, insofar as they do not depart from the spirit and scope of the present invention.

It is a primary objective of the present invention to provide an improved ladder with a support device for easy transport at the work place that may be easily and efficiently manufactured and marketed.

It is another objective of the present invention to provide an improved ladder with a support device at a low cost of manufacture with regard to both materials and labor and is, therefore, economically available to the buying public.

Another objective of the present invention is to provide a ladder with a wheel as a support device for easy transport at the work place.

Another objective of the present invention is to provide a ladder with a wheel as a support device attached at the top of the ladder.

Another objective of the present invention is to provide a ladder with a wheel as a support device attached at the top of the ladder between the top of the ladder and first step.

Another objective of the present invention is to provide ladder with a wheel as a support device attached using a bungee buckle.

Another objective of the present invention is to provide ladder with a wheel as a support device attached using a cinch style buckle.

Yet another objective of the invention is to provide ladder with a wheel as a support device that can be easily unbuckled and used with all types of ladders.

Yet another objective is that the system is simple to use.

The invention relates to a support device, and to a ladder that includes that support device. The support device of the invention includes means for positioning the ladder on an inclined surface. The support member includes a bracket member and a rotatable device, such as a wheel, housed in the bracket member. The bracket member includes a U-shaped section for retaining the wheel member, and an elongated section for attachment to the ladder. The elongated section can be at a substantially right angle to the U-shaped section. The device is used for easily moving the ladder from one place to another.

In addition to the various objectives and advantages of the present invention, described with some degree of specificity above, it should be obvious that additional objectives and advantages of the present invention will become more readily apparent to those persons who are skilled in the relevant art from the following more detailed description of the invention, particularly when such description is taken in conjunction with the attached drawing FIGURES.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 shows the front view of the wheel device according to the current invention.

### DETAILED DESCRIPTION OF THE INVENTION

A detailed description of one or more embodiments of the invention is provided below, along with accompanying FIGURES that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

As a preface to the detailed description, it should be noted that, as used in this specification, the singular forms “a”, “an” and “the” include plural referents, unless the context clearly dictates otherwise.

The invention relates to a ladder that includes a support device. A mounting plate is securely fixed to an outer surface of a side rail of a ladder, which is adjacent to one end of the ladder. A removable wheel assembly has a frame that is removably supported on mating inter-fitting parts between the wheel assembly and the support member or the plate. The support member includes a bracket member and a rotatable device, such as a wheel, housed in the bracket member. The bracket member includes a U-shaped section for retaining the wheel member, and an elongated section for attachment to the ladder. The device is used for easily moving the ladder from one place to another. The interchange from one ladder to another is simply by unbuckling it from one ladder, pulling it off, sliding it onto the new ladder, and buckling it back on. The ladder wheel should be placed between the top of the ladder and the first step from the top of the ladder.

The wheel member extends out from the outer face and rotates on an axis that is parallel to the plane of the outer face. A support plate is placed in contact with the inner face of the side rail and is operably attached to the wheel. The wheel is preferably positioned adjacent the bottom end of the side rail so that the ladder may be transported on its side by grasping the top end with one hand and allowing the wheel to contact and roll along the ground. For dual access folding stepladders, a wheel is attached to each of the side rails on one side of the ladder.

The dimensions of the piece that slides on the ladder is in a U shape, which is 3(⅜)″×4″×13″ W×L×D with two pieces 1(½)″×1(¼)′″ with a rounded end on it where the wheel is attached and a 1″ 90 on the other end to attach to the U shaped piece made out of 16 gauge galvanized steel. The wheel is a rubber wheel that is 2″×3(¼)′″ H×W and has a (¼)″ hole to attach to the steel.

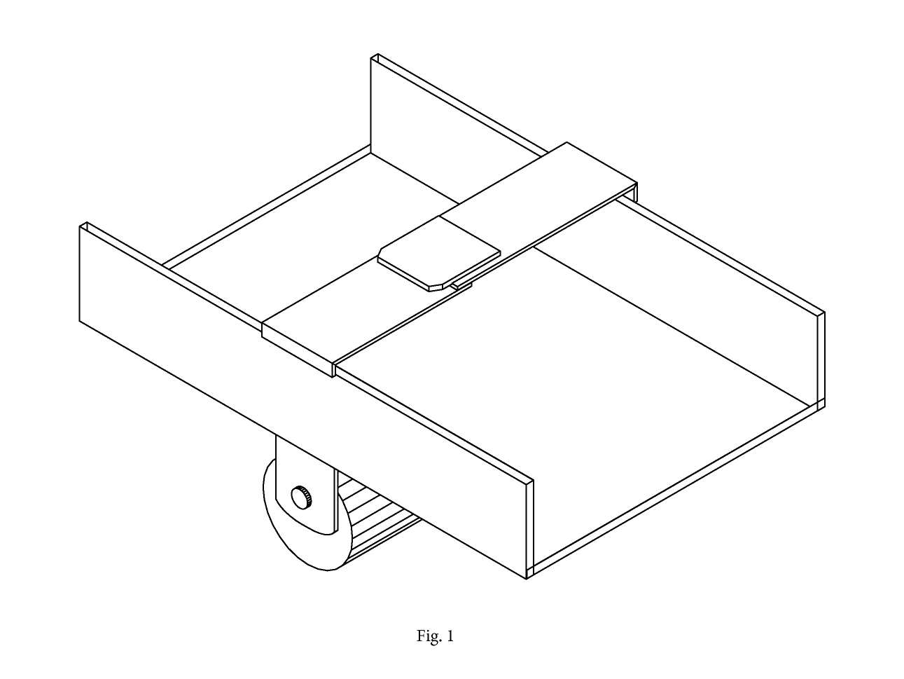

In one preferred embodiment of the invention, the fastening means that is used for securing the invention device with the ladder for which it is used is simply a ⅛″×¼″ rod provided at each side of the U shaped body, as shown in the FIG. 1. The U shaped body goes around the ladder post and is around (4×6×4)″. The rods are further held in place using the bungee strap that goes over the ladder.

In another preferred embodiment of the invention, the buckle is attached with a hinge on one side and has a catch on the other with a cinch style buckle in the middle. It is made with ⅙″ gauge steel and ⅙″ rod.

Turning now descriptively to the drawings, in which similar reference characters denote similar elements throughout the several views, the FIGURES illustrate the support device according to the invention.

FIG. 1 illustrates the front view of the invention device illustrating the wheel with ¼″ hole in the middle. The U shaped piece slides onto the ladder and buckles there. The buckled device is strong enough to support the weight of the ladder when rolled on the floor for transporting, thereby reducing the physical stress of the workman that otherwise occurs during transporting ladders.

Now turning to the materials required, includes fiberglass, steel gauge, and rubber for the wheel. The buckle is made of gauge steel and steel rod.

Advantages of the invention include: the ladder wheel device will fit most ladders as it slides on the side of the ladder so it won't matter how tall or short the ladder is. It gives a simple option to place the device from one ladder to another by unbuckling from one ladder and buckling right back on the next ladder. The ladder will be safely transported by the user as the wheel is fixed by buckling preventing any accidents when user is moving the ladder.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions and improvements to the embodiments described above are possible. It is contemplated that these variations, modifications, additions, and improvements fall within the scope of the invention. Those skilled in the art should appreciate that they can readily use the disclosed conception and specific embodiment as a basis for designing or modifying other structures for carrying out the same purposes of the present invention, and that such other structures do not depart from the spirit and scope of the invention in its broadest form.

1. A ladder with support device for easy transport at the work place comprising:
a mounting plate to fix said device on said ladder;
support member or plate;
a frame; and
bracket member;
wherein said support device is a rotatable device is placed between the top of the ladder and the first step from the top of the ladder.

2. A ladder with support device for easy transport as claimed in claim 1, wherein said mounting plate to fix said device on said ladder is securely fixed to an outer surface of a side rail of a ladder, which is adjacent to one end of the ladder.

3. A ladder with support device for easy transport as claimed in claim 1, wherein said support member or plate is further comprised of said bracket member and a rotatable device.

4. A ladder with support device for easy transport as claimed in claim 1, wherein said rotatable device is a wheel that is housed in the bracket member, at east one in number.

5. A ladder with support device for easy transport as claimed in claim 1, wherein said frame which is removably supported on mating inter-fitting parts between said wheel and the support member or plate.

6. A ladder with support device for easy transport as claimed in claim 1, wherein said bracket member includes a U-shaped section for retaining the wheel and an elongated section for attachment to the ladder.

7. A ladder with support device for easy transport as claimed in claim 1, wherein said ladder is used for easy transport at the work place.

8. A ladder with support device for easy transport as claimed in claim 1, wherein said ladder with said wheel as a support device is attached using a bungee buckle.

9. A ladder with support device for easy transport as claimed in claim 1, wherein said ladder with said wheel as a support device is attached using cinch style buckle.

10. A ladder with support device for easy transport as claimed in claim 1, wherein said ladder with said wheel as a support device can be easily unbuckled and used for all types of ladders available.

11. A ladder with support device for easy transport of said ladder at the work place comprising:
a mounting plate to fix said device on said ladder that is securely fixed to an outer surface of a side rail of a ladder, adjacent one end of the ladder;
support member or plate, wherein said support member or plate is further comprised of said bracket member and a rotatable device;
a frame, wherein said frame which is removably supported on mating inter-fitting parts between said wheel and the support member or plate; and
bracket member, wherein said bracket member includes a U-shaped section for retaining the wheel and an elongated section for attachment to the ladder;
wherein said support device is a rotatable device is a wheel placed between the top of the ladder and the first step from the top of the ladder.

12. The dimensions of the device as claimed in claim 11 comprises of:
the dimensions of the piece that slides on the ladder is in a U shape body which is 3(⅜)″×4″×13″ W×L×D with two pieces 1(½)″×1(¼)′″ with a rounded end on it where the wheel is attached and a 1″ 90 on the other end to attach to the U shaped piece made out of 16 gauge galvanized steel;
said wheel is a rubber wheel that is 2″×3(¼)′″ H×W and has a (¼)″ hole to attach to the steel.

13. A ladder with support device as claimed in claim 11, wherein said U shaped body that goes around the ladder is (4×6×4)″.

14. A ladder with support device as claimed in claim 11, wherein said U shaped body slides onto the ladder and buckles there.

15. The method of easily moving the ladder from one place to another comprises:
Placing the support wheel device on the ladder using a bungee strap on the buckle wherein the device is placed on the top of the ladder between first step and top of ladder; and
transporting ladder with the support device placed on said ladder at different work places using said wheel device.

16. The method of easily moving the ladder from one place to another as claimed in claim 15, wherein said device can be interchanged from one ladder to another comprising steps as:
unbuckling said device from one ladder,
pulling said device off,
bucking said device back on the next ladder,
sliding said device on the new ladder; and
using the device to transport ladders at different places.
